(19) United States
(12) Patent Application Publication
(10) Pub. No.: US 2013/0077961 A1
(43) Pub. Date: Mar. 28, 2013

(54) TECHNIQUES FOR GENERATING LOW RATE DATA PATTERNS COMPLIANT WITH PASSIVE OPTICAL NETWORKS

(71) Applicants: Amiad Dvir, Nes-Ziona (IL); Assaf Amitai, Tel Aviv (IL)

(72) Inventors: Amiad Dvir, Nes-Ziona (IL); Assaf Amitai, Tel Aviv (IL)

(73) Assignee: BROADLIGHT, LTD., Herzliya (IL)

(21) Appl. No.: 13/246,192

(22) Filed: Sep. 27, 2011

(51) Int. Cl. H04B 10/08

(52) U.S. Cl. 398/16

(57) ABSTRACT

An apparatus for generating a reflection analysis data pattern (RADP) being utilized for performing a reflection analysis in a PON. The apparatus comprises a data pattern generator for generating a low rate data pattern using a low rate polynomial; a high rate adaptor for increasing a rate of the low rate data pattern to a transmission rate of the PON; first and second scrambler polynomial generators for generating first and second data sequences according to a scrambler polynomial of the PON; a pre-scrambler for scrambling a high-rate data pattern with the first data sequence; a scrambler coupled to the pre-scrambler for scrambling the output of the pre-scrambler with a time-shifted signal of the second data sequence to result with the RADP; and an encapsulator for encapsulating the reflection analysis data pattern output by the scrambler in a plurality of downstream frames transmitted from an OLT to ONUs of the PON.

### TECHNICAL FIELD

The present invention relates generally to passive optical networks (PONs), and more specifically for generating low rate data patterns that can be utilized for reflection analysis and transmission of such patterns in PONs.

### BACKGROUND OF THE INVENTION

A passive optical network (PON) comprises an optical line terminal (OLT) connected to multiple optical network units (ONUs) in a point-to-multi-point network. New standards have been developed to define different types of PONs, each of which serves a different purpose. For example, the various PON types known in the related art include a Broadband PON (BPON), an Ethernet PON (EPON), a Gigabit PON (GPON), a 10-Gigabit PON (XG-PON), and others.

An exemplary diagram of a typical PON 100 is schematically shown in FIG. 1. The PON 100 includes N ONUs 120-1 through 120-N (collectively known as ONUs 120) coupled to an OLT 130 via a passive optical splitter 140. In a GPON, for example, traffic data transmission is achieved using GPON encapsulation method (GEM) encapsulation over two optical wavelengths, one for the downstream direction and another for the upstream direction. Thus, downstream transmission from the OLT 130 is broadcast to all the ONUs 120. Each ONU 120 filters its respective data according to pre-assigned labels (e.g., GEM port-IDs in a GPON). The splitter 140 is 1 to N splitter, i.e., capable of distributing traffic between a single OLT 130 and N ONUs 120. In most PON architectures, the upstream transmission is shared between the ONUs 120 in a TDMA based access, controlled by the OLT 130. TDMA requires that the OLT first discovers the ONUs and measures their round-trip-time (RTT), before enabling coordinated access to the upstream link.

In order to provide reliable operation of the PON, there is a need to identify faults that occur on the optical fibers and/or optical components of the PON, for example, detection of breaks or major attenuation, due to a bent fiber or dirty connector. Additionally, in order to allow repairing a faulty optical fiber, there is a need to locate the exact location of the fault for a faster, more efficient network repairs.

Optical faults and their locations in the PON can be detected using optical time-domain reflectometers (OTDRs). The principle of an OTDR includes injecting, at one end of the fiber, a series of optical pulses into the fiber under test and also extracting from the same end of the fiber, light that is scattered (Rayleigh backscatter) or reflected back from points along the fiber. The strength of the return pulses is measured and integrated as a function of time and may be plotted as a function of fiber length. The results may be analyzed to determine the fiber's length, overall attenuation, optical faults, such as breaks, and to measure optical return loss.

OTDR measurements can be performed in the PON using “out-of-band”, “in band” or dedicated wavelength techniques. Out-of-band testing requires stopping the normal operation of the network and verifying the fiber using external OTDR tools. This can be performed using, for example, wavelengths and test pulses that are separate and independent from and different from other wavelengths used to carry customer service traffic.

The in-band testing is performed when the network is operational. However, such a testing requires dedicated OTDR testing signals. The OTDR testing signals utilized in conventional in-band OTDR solutions are either AM modulated or FM modulated. However, such signals can be transmitted only during a test period of the PON, during which data signals are not transmitted to the ONUs. Other OTDR solutions utilize a dedicated upstream wavelength for measuring reflection from the fiber.

It would be therefore advantageous to provide a solution for generating and transmitting signals that can be utilized for testing the reflection in a PON while overcoming the deficiencies of prior art testing techniques.

### SUMMARY OF THE INVENTION

Certain embodiments include herein include an apparatus for generating a reflection analysis data pattern being utilized for performing a reflection analysis in a passive optical network (PON). The apparatus comprise a data pattern generator for generating a low rate data pattern using a low rate polynomial; a high rate adaptor for increasing a rate of the low rate data pattern to a transmission rate of the PON, the high rate adaptor outputs a high-rate data pattern; a first scrambler polynomial generator for generating a first data sequence according to a scrambler polynomial of the PON; a second scrambler polynomial generator for generating a second data sequence according to the scrambler polynomial of the PON; a pre-scrambler for scrambling the high-rate data pattern with the first data sequence; a scrambler coupled to the pre-scrambler for scrambling the output of the pre-scrambler with a time-shifted signal of the second data sequence to result with the reflection analysis data pattern; and an encapsulator for encapsulating the reflection analysis data pattern output by the scrambler in a plurality of downstream frames transmitted from an optical line terminal (OLT) to optical network units (ONUs) of the PON.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is a schematic diagram of a PON.

FIG. 2 is a diagram illustrating an apparatus for generating a reflection analysis data pattern.

FIG. 3 shows a structure of a GEM frame utilized to carry a reflection analysis data pattern according to an embodiment of the invention.

FIGS. 4A, 4B and 4C show downstream transmission of GEM frames carrying segments of the reflection analysis data pattern.

FIG. 5 shows a structure of a XGEM frame utilized to carry a reflection analysis data pattern according to an embodiment of the invention.

FIG. 6 shows a structure of a XG-PON1downstream physical (PHY) layer frame utilized to carry a reflection analysis data pattern according to an embodiment of the invention.

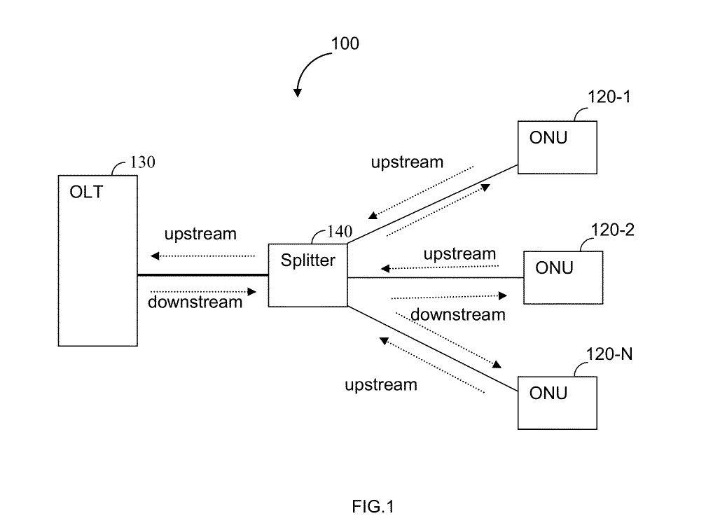

### DETAILED DESCRIPTION OF THE INVENTION

It is important to note that the embodiments disclosed are only examples of the many advantageous uses of the innovative teachings herein. In general, statements made in the specification of the present disclosure do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

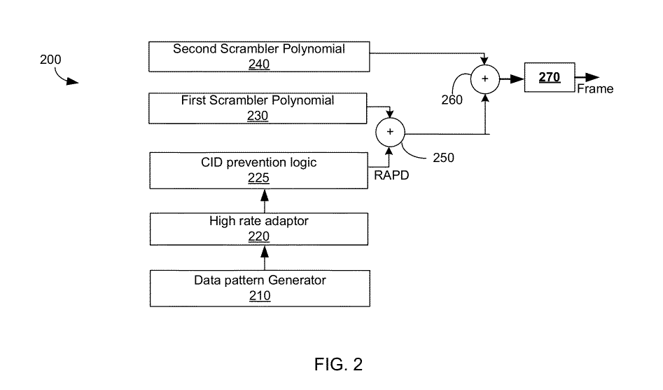

FIG. 2 shows an exemplary and non-limiting block diagram of an apparatus 200 for generating a continuous data pattern that can be utilized for performing a reflection analysis in a PON and injecting the generated pattern in the downstream data according to certain embodiments of the invention. This data pattern will be referred to hereinafter as the reflection analysis data pattern (RADP). According to an embodiment of the invention, the RADP is a high rate (frequency) pattern that has dominant low rate components with specific characteristics required to perform the refection analysis. The RADP, in an embodiment of the invention, can be a semi-continuous, i.e., segmented to a plurality of data segments. One technique for performing reflection analysis can be found in a co-pending patent application entitled “A SYSTEM AND METHOD FOR PERFORMING IN-BAND REFLECTION ANALYSIS IN A PASSIVE OPTICAL NETWORK”, assigned to the common assignee of the present application.

The RADP is transmitted in the downstream direction as part of the data frames sent from the OLT to ONUs. Thus, the RADP is fully compliant with the communication standards of the PON. Certain embodiments of the invention include the encapsulation of the RADP in GEM frames and XGEM frames. A GEM frame's structure is defined in the GPON standard ITU-T G.984.3, while the XGEM frame's structure is specified in the XGPON standard ITU-T G.987.3.

The RADP can be utilized for performing reflection analysis between transmitted downstream frames including the RADP and reflected signals respective of the RADP as received at the OLT. The reflection analysis results can be processed by an OTDR processor to, at least, detect faults and their locations in the optical path of PON.

In an embodiment of the invention, the apparatus 200 is implemented in the OLT and includes a data pattern generator 210, a high rate adaptor 220, a consecutive identical digits (CID) prevention logic 225, a first scrambler polynomial generator 230, a second scrambler polynomial generator 240, a pre-scrambler 250, a scrambler 260, and an encapsulator 270. A low rate data pattern is generated by the data pattern generator 210 using a low rate polynomial. In an embodiment of the invention, this polynomial is selected from a group of polynomials designed for generating a pseudorandom binary sequence pattern (PRBS). Then, the high rate adaptor 220 applies a full rate repeating bits function on the generated data pattern. This is performed in order to adapt the low rate (frequency) data pattern to the rate of the PON. For example, if the rate of the pattern output by the generator 210 is 155.52 Mbit/sec, then the rate should be 16 times higher to meet the transmission rate of the GPON. Thus, the high rate adaptor 220 repeats every bit in the low rate pattern 16 times. In XGPON transmission, the high rate adaptor 220 repeats every bit in the low rate pattern 64 times.

The CID prevention logic 225 eliminates the occurrence of consecutive identical bits to meet the CID requirement set by the respective PON standard or may be set to a value determined by the user. In the ITU-T G.984.3 standard, the CID number should be less than 72 bits. Thus, in a non-limiting embodiment, the logic 225 searches for (K-1) identical bits and inverts (i.e., a high logic value to a low logic value, and vice versa) the value of the K-th bit to avoid a CID number exceeding the requirement. The parameter K is set to a value of the maximum allowable or user selected identical bits allowed by the standard (e.g., 72). The output of the CID prevention logic 225 is the RADP.

Each of the first and second scrambler polynomial generators 230 and 240 outputs a data sequence according to the scrambler polynomial defined by the respective PON standard. In an embodiment of the invention, the scrambler polynomial is (X7+X6+1) as utilized by a GPON's OLT. In another embodiment, the scrambler polynomial is (X58+X39+1) as utilized by a XGPON's OLT

The pre-scrambling operation, performed by the pre-scrambler 250, includes a XOR operation between the generated RADP and a data sequence output by the first scrambler polynomial generator 230. The output of the pre-scrambler 250 is scrambled, by means of the scrambler 260, with a shifted-version of a data sequence output by the second scrambler polynomial generator 240. The scrambling of data prior to transmission is a mandatory operation that should be performed by the OLT. The pre-scrambling and scrambling operations cancel each other, thus the RADP is transmitted in the output frames. It should be noted that this process ensures that the generated RADP will be included in the transmitted frames, thus providing a control over the data inserted in the frames.

The data sequence generated by the generator 240 is time shifted to allow the XOR-ing operation (performed by the scrambler 260) to be performed on two aligned patterns. Typically, pre-scrambling and scrambling operations occur at different times due to the pipelining. That is, when the scrambler 260 processes the i-th bit, the pre-scrambler 250 processes bit i+M, where M is a constant number that represents the pipeline delay between the pre-scrambler 250 and scrambler 260. Thus, at each time, the data sequence in the output of the second generator 240 is shifted M bits.

In an embodiment of the invention, when the apparatus 200 is implemented in an OLT operable in a XGPON network, each of the first and second scrambler polynomial generators 230 and 240 generates according to the polynomial (X58+X39+1). In addition, the shifted version of the data sequence output by the generator 240 is initialized with a value which is a function of the current value of the superframe counter. The superframe counter is part of the XG-PON1 physical (PHY) layer frame (see FIG. 6).

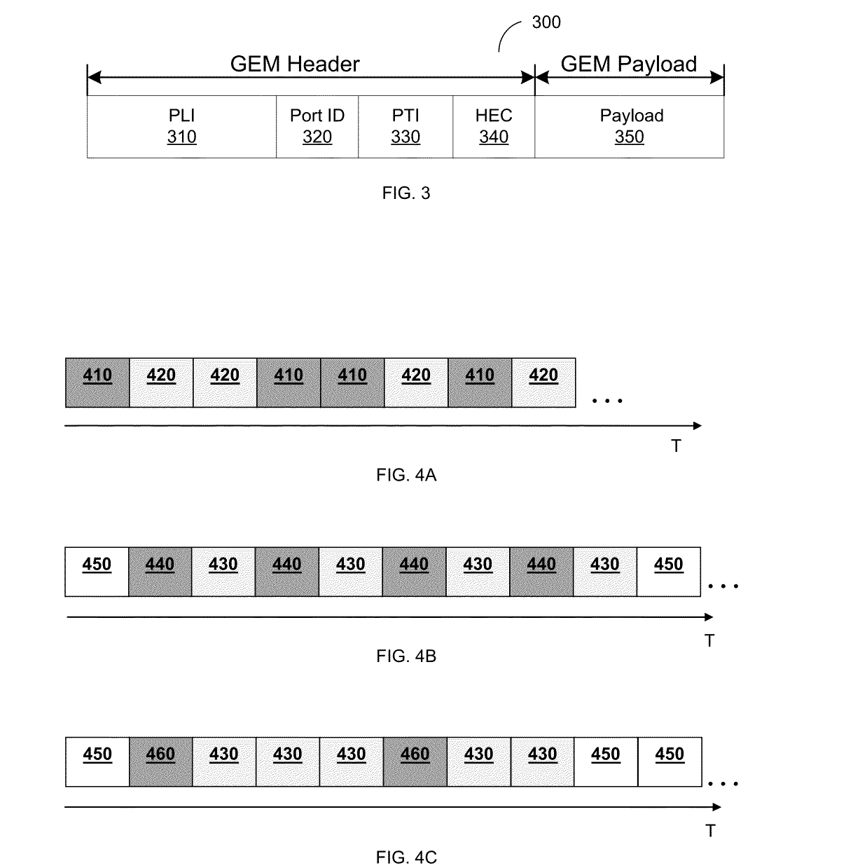

The encapsulator 270 is utilized to insert the generated RADP, or segments thereof in the frames transmitted in the downstream direction. The various techniques performed by the encapsulator 270 are discussed below with reference to FIGS. 3-6. In an embodiment of the invention, a MAC module of an OLT can be adapted to perform the various embodiments of the encapsulator 270.

FIG. 3 shows an exemplary GEM frame 300 utilized to describe an embodiment of the invention for encapsulation of the reflection analysis data pattern (RADP) in GEM frames. A GEM frame is a data structure, defined in the GPON standard ITU-T G. 984.3, for transmission of data from OLT to ONUs, and vice versa. The GEM frame includes a GEM header, which specifies certain provisions in the transmitted GEM frame, followed by a GEM payload. As illustrated in FIG. 3, the GEM header includes a payload length (PLI) field 310, a port identified (ID) field 320, a payload type indicator (PTI) field 330, a header error correction (HEC) field 340, and a payload portion 350.

According to an embodiment of the invention, the GEM frame 300 is adapted to carry the RADP by setting its various fields as follows. The PLI field 310 is set to the number of bytes that can be included in a current frame 300. This number may be any value up to the maximum bytes allowable by the standard. For example, when a downstream forward error correction (FEC) mode is disabled, data fragments up to 4095 bytes are allowed to be transmitted. Thus, the PLI field 310 designates the value 4095 bytes or less. The port ID field 320 usually designates a target ONU for the frame. In this embodiment, the port ID field 320 includes an identifier that is not associated with any of the ONUs in the PON. Thus, none of the ONUs will process the frame 300. The PTI field 330 is set to an appropriate value (e.g., ‘001’ indicating end of fragment of user data). The HEC field 340 includes an error correction code computed based on the values of the fields 310, 320, and 330.

The generated RADP, or segments thereof, is carried in the payload portion 350. As mentioned above, the RADP is a continuous data pattern utilized for reflection analysis. As such, the length of the RADP is typically longer than the length (in bytes) of the payload portion 350. Thus, according to an embodiment of the invention, the RADP generated as described in detail above, is transmitted in a plurality of GEM frames 300. The transmission of the GEM frames carrying the RADP segments may be transmitted in any order and can be interleaved with GEM frames carrying data packets. That is, there is no requirement for consecutive transmissions of GEM frames including segments of the RADP.

FIG. 4A shows an example for transmission of GEM frames when the FEC mode is disabled. GEM frames 410 carry in their payloads, segments of the generated RADP while frames 420 include user data. As depicted in FIG. 4A, the GEM frames 410 can be transmitted in any order in the downstream direction.

According to another embodiment of the invention, the fields of the GEM frame (e.g., frame 300) are set to different values when the FEC is enabled in the downstream direction. The GPON utilizes Reed-Solomon RS(255,239) correction code. The length (size) of a GEM frame is 239 bytes, 5 bytes for the GEM header and 234 bytes for the payload 250. The number of parity bytes of a RS(255, 239) codeword is 16. The parity bytes are not part of the GEM frame, but rather are a trail of the GEM frame. With this FEC codeword, the longest continuous available segment in the payload portion 350 is 234 bytes. Accordingly, in this embodiment of the invention, the value of the PLI field 310 is set to a value of up to 234 bytes. The port ID 320, PTI 330, and the HEC 340 fields are set as described above. In the payload potion 350, a segment of 234 bytes from the generated RADP is inserted.

In an embodiment of the invention, in order to ensure transmission of a continuous segment of the RADP in a GEM frame, a dummy GEM frame is created to fill the data portion of the current FEC codeword and then a RADP segment is inserted starting at the beginning of the payload portion of the next FEC codeword. That is, a non-fragmented RADP segment is included in the next GEM frame. The ONU ID field of the dummy GEM frame is set to the same value as of the GEM frames carrying the RADP segments, so that the dummy GEM frame will not be processed by the ONUs.

The GEM frames carrying the RADP segments may be transmitted in any order and can be interleaved with GEM frames carrying data packets. That is, there is no requirement for consecutive transmissions of GEM frames to include segments of the RADP. However, the dummy GEM frame should precede a GEM frame carrying a RADP segment or a group of consecutive GEM frames.

FIG. 4B shows an example for transmission of GEM frames when the FEC mode is enabled. GEM frames 440 are dummy frames, GEM frames 430 carry in their payloads RADP segments, each of which having a length that is less than 234 bytes, and GEM frames 450 include user data.

FIG. 4C shows an example for transmission of GEM frames when the FEC mode is enabled. GEM frames 460 are dummy frames, GEM frames 430 carry in their payloads RADP segments, and GEM frames 450 include user data. The size of each of the RADP segments is 234 bytes, thus the payload's size of the GEM frame 440 is 234 bytes. In this example, a single dummy frame 460 precedes a sequence of GEM frames. Each of GEM frames 430, 440, 450, and 460 are the same as the structure shown in FIG. 3.

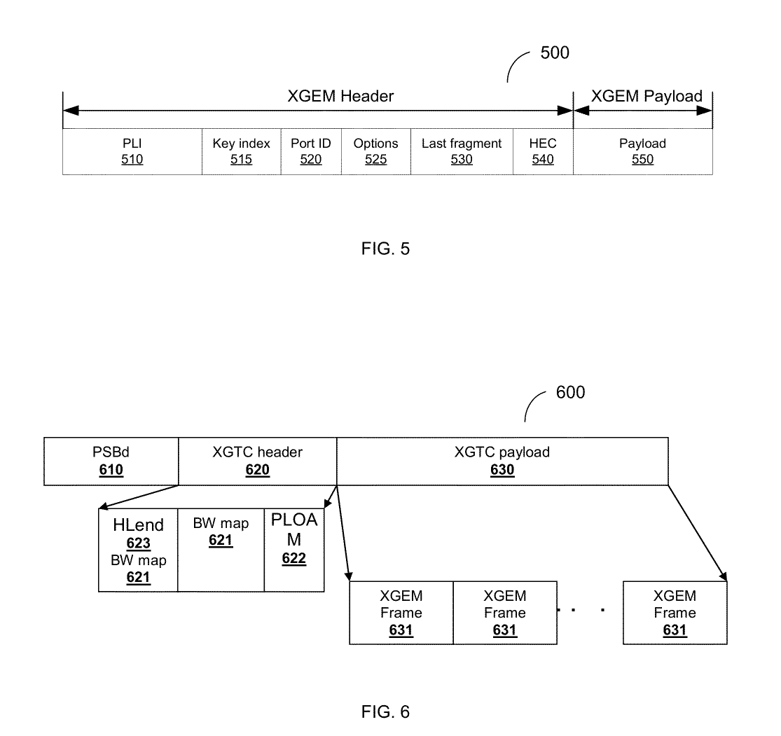

FIG. 5 shows an exemplary XGEM frame 500 utilized to describe an embodiment of the invention for encapsulation of the reflection analysis data pattern (RADP) in transmitted XGEM frames. A XGEM frame is a data structure, defined in the XGPON standard ITU-T G.987.3, for transmission of data in the downstream direction from OLT to ONUs. A XGEM frame also consists of a XGEM header and a XGEM payload.

As illustrated in FIG. 5, the XGEM frame 500 includes a payload length (PLI) field 510, a key index field 515, a port identified (ID) field 520, an optional field 525, a last fragment indication 530, a header error correction (HEC) field 540, and a payload portion 550.

According to an embodiment of the invention, the XGEM frame 500 is adapted to carry the RADP by setting its various fields as follows. The PLI field 510 is set to the maximum number of bytes that can be included in a current XGEM frame 500. This number may be any value up to the maximum bytes allowable by the standard. According to the XGPON specification, a downstream forward error correction (FEC) mode is mandatory. Thus, only data fragments up to 208 data bytes are allowed to be transmitted in the frame and the rest of the bytes are error codewords. The key index includes a ‘00’ value, which designates no encryption of the data. The port ID field 520 usually designates a target ONU for the frame. In this embodiment, the port ID field 520 includes an ONU identifier that is not associated with any ONU in the PON or an idle port ID. That is, none of the ONUs will process the XGEM frame 500. The HEC 540 includes an error correction code computed based on the values of the fields 510, 515, 520, 525, and 530.

The generated RADP, or segments thereof, is carried in the payload portion 550. As mentioned above, the RADP is a continuous data pattern utilized for reflection analysis. As such, the length of the RADP is typically longer than the length (in bytes) of the payload portion 500. Thus, according to an embodiment of the invention, the RADP generated as described in detail above, is transmitted in a plurality of GEM frames 500. The XGEM frames carrying the RADP segments may be transmitted in any order and can be interleaved with XGEM frames carrying data packets. However, to ensure a continuous segment having the maximum length (e.g., 208 bytes), one or more idle XGEM frames are transmitted before an XGEM frame carrying a segment of the generated RADP. The idle frame or frames fill the payload portion (a data portion of a FEC codeword) of the current FEC codeword. As mentioned above, this allows including a 208-byte long RADP segment in a payload portion of the payload portion of the next XGEM frame.

According to another embodiment of the invention, the generated RADP is inserted in a number of consecutive XGEM frames of an entire XG-PON1 downstream PHY frame 300. As illustrated in FIG. 6, the XG-PON1 downstream PHY frame 600 includes a physical synchronization block (PSBd) portion 610, a XGPON transmission convergence layer (XGTC) header 620, and a XGTC payload 630. The duration of a downstream PHY frame 600 is 125 microsecond. The PSBd 610 defines certain provisions for the transmission of the downstream PHY frame 600, and particularly, includes the superframe counter utilized for the generation of the RADP as described above.

The XGTC header 620 includes a HLend field 623, which designates the number of BW maps and PLOAMs for the current frame, a predefined number of bandwidth (BW) maps 621 and physical layer operations and maintenance (PLOAM) messages 622. The bandwidth maps 621 and PLOAMs 622 can be optionally paused when transmitting XGEM frames with RADP segments. In this case, the HLend field 623 is set to zero. The XGTC payload 630 includes a plurality of XGEM frames 631, each of which has the structure of the frame illustrated in FIG. 5.

At maximum utilization of the downstream PHY frame, 135,356 bytes of RADP at a rate of the XGPON (9.95328 Gbit/sec) can be transmitted. For each XGEM frame 631, the maximum number of bytes that can be transmitted without padding bytes are 16380, thus the PLI value (in the XGEM header) is set to a value of up to 16380 bytes. The rest of the XGEM header fields are set as described above with respect to FIG. 5. The RADP is inserted payload portion of the XGEM frame.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An apparatus for generating a reflection analysis data pattern being utilized for performing a reflection analysis in a passive optical network (PON), comprising:
a data pattern generator for generating a low rate data pattern using a low rate polynomial;
a high rate adaptor for increasing a rate of the low rate data pattern to a transmission rate of the PON, the high rate adaptor outputs a high-rate data pattern;
a first scrambler polynomial generator for generating a first data sequence according to a scrambler polynomial of the PON;
a second scrambler polynomial generator for generating a second data sequence according to the scrambler polynomial of the PON;
a pre-scrambler for scrambling the high-rate data pattern with the first data sequence;
a scrambler coupled to the pre-scrambler for scrambling the output of the pre-scrambler with a time-shifted signal of the second data sequence to result with the reflection analysis data pattern; and
an encapsulator for encapsulating the reflection analysis data pattern output by the scrambler in a plurality of downstream frames transmitted from an optical line terminal (OLT) to optical network units (ONUs) of the PON.

2. The apparatus of claim 1, further comprises a consecutive identical digits (CID) prevention unit for inverting a n-th bit in the high-rate data pattern, wherein the n-th bit is determined based on at least one of a number of allowable consecutive identical bits in the reflection analysis data pattern and a user defined parameter.

3. The apparatus of claim 2, wherein the reflection analysis data pattern is a non-fragmented high rate data pattern that includes low rate components.

4. The apparatus of claim 2, wherein the low rate polynomial is selected from a group of polynomials designed for generating a pseudorandom binary sequence pattern (PRBS).

5. The apparatus of claim 1, wherein the PON is a Gigabit PON (GPON).

6. The apparatus of claim 5, wherein the encapsulator is configured to insert segments of the reflection analysis data pattern in GEM frames, wherein each segment of the reflection analysis data pattern has a maximum allowable length that can fit a payload portion of a GEM frame.

7. The apparatus of claim 6, further comprises:
setting a port identifier (ID) field in a GEM header of the GEM frame with an identifier that is not associated with any of the ONUs.

8. The apparatus of claim 6, wherein the encapsulator is configured to interleave transmission of GEM frames including segments of the reflection analysis data pattern with GEM frames carrying user data.

9. The apparatus of claim 8, the encapsulator is further configured to generate a dummy GEM frame when a FEC mode of the GPON is enabled, wherein the dummy GEM frame includes a data portion of a current forward error correction (FEC) codeword.

10. The apparatus of claim 9, wherein a segment of the reflection analysis data pattern is inserted at a beginning of a payload portion of a GEM frame that follows the dummy GEM frame, when the FEC mode of the GPON is enabled.

11. The apparatus of claim 1, wherein the PON is a 10-Gigabit PON (XG-PON).

12. The apparatus of claim 11, wherein the encapsulator is configured to insert segments of the reflection analysis data pattern in XGEM frames, wherein each segment of the reflection analysis data pattern has a maximum allowable length that can fit a payload portion of a XGEM frame.

13. The apparatus of claim 12, further comprises:
setting a port identifier (ID) field in a XGEM header of the XGEM frame with an identifier that is not associated with any of the ONUs.

14. The apparatus of claim 12, wherein the encapsulator is further configured to generate one or more idle XGEM frames, wherein each of the one or more idle XGEM frames includes a data portion of a current forward error correction (FEC) codeword.

15. The apparatus of claim 14, wherein a segment of the reflection analysis data pattern is inserted at a beginning of a payload portion of a XGEM frame that follows the one or more idle XGEM frames.

16. The apparatus of claim 12, wherein the XGEM frames including segments of the reflection analysis data pattern are consecutive XGEM frames of an entire physical (PHY) layer frame.

17. The apparatus of claim 1, wherein the reflection analysis can be utilized to detect optical faults in the PON.

18. The apparatus of claim 1, is integrated in the OLT.

19. An optical line terminal (OLT) operative in a passive optical network (PON) and configured to generate a data structure that includes a segment of a reflection analysis data pattern being utilized for performing a reflection analysis in the PON, wherein the data structure includes:
a header portion that includes a optical network unit (ONU) identifier being set with an identifier that is not associated with any ONUs of the PON; and
a data portion that carries the segment of the reflection analysis data pattern, wherein the segment is inserted in the payload portion starting with the first byte of the payload portion, wherein the reflection analysis data pattern is a non-fragmented high rate data pattern that includes low rate components.

20. The OLT of claim 19, wherein the PON is any one of a Gigabit PON (GPON) and a 10-Gigabit PON (XG-PON).
